(19) United States
(12) Patent Application Publication
(10) Pub. No.: US 2004/0002357 A1
(43) Pub. Date: Jan. 1, 2004

(54) Directional antennas and wireless channel access

(76) Inventor: Mathilde Benveniste, South Orange, NJ (US)

Correspondence Address: Mathilde Benveniste, 76 Harding Drive, South Orange, NJ, 07079, US

(21) Appl. No.: 10/603,263

(22) Filed: Jun. 24, 2003

Related U.S. Application Data
(60) Provisional application No. 60/391,451, filed on Jun. 25, 2002.

(51) Int. Cl. H04M 1/00; H04B 1/38

(52) U.S. Cl. 455/550.1; 455/561; 455/562.1

(57) ABSTRACT

A method is disclosed for addressing the problem of uplink capture, which arises in a multiple-cell wireless LAN using directional antennas. The use of directional antennas may adversely impact the performance of channel access protocols. CSMA-type MAC protocols provide dynamic bandwidth allocation in a distributed manner, eliminating idle time intervals. With such protocols, time-overlapped uplink transmissions by stations illuminated by different beams cooperate to capture the channel for long time periods. Without special measures, an imbalance could arise in the opportunity for the AP to access the channel, which could result in downlink delay and jitter and overall capacity loss. According to this invention, the uplink capture problem is mitigated by requiring all (non-AP) stations to release the channel at pre-specified times.

### BACKGROUND OF THE INVENTION

1. Field of the Invention

This invention relates to wireless communications and more particularly relates-to multiple medium access in a system employing directional antennas supporting multiple beams.

2. Related Art

Wireless LANs provide wireless peer-to-peer communication between stations and access to the wired network. A station in a wireless LAN (WLAN) can be a personal computer, a bar code scanner, or other mobile or stationary device with the appropriate integrated chip set or a wireless network interface card to make the connection over a wireless link to other stations. A single-cell WLAN may serve a group of stations communicating directly via the wireless medium; this is called an ad hoc network. Single-cell WLANs are suitable for small single-floor offices, stores, and the home network where data is exchanged directly. Multiple-cell WLANs provide greater range than single-cell WLANs by using access points (APs) to interconnect several single-cell WLANs. The AP can be thought of as the counterpart of the base station of a mobile cellular communications system. Communication among stations, or between a station and the wired network, may be established with the aid of a wired backbone network, known as the distribution system. An AP is a station that serves as a gateway to the distribution system; it is analogous to the base station of a cellular communications network. Such a WLAN is known as an infrastructure network, to distinguish it from single-cell

Of the multitude of wireless LAN specifications and standards, IEEE 802.11 technology has emerged as a dominant force for the enterprise WLAN market over the past years. A description of this technology is available from the IEEE, Inc. web site http://grouper.ieee.org/groups/802/11

Wireless LANs operate in the unlicensed portions of the spectrum, where they provide interference-free simultaneous transmissions on multiple channels; each cell transmits on a single time division duplex (TDD) channel. The number of channels available varies with the spectrum allocation and physical layer technology. For instance, the IEEE 802.11b standard provides 3 TDD channels for duplex data transmission at speeds up to 11 Mbps in the 2.4 GHz ISM band, while EEE 802.11a provides 8 channels at speeds up to 54 Mbps in the 5 GHz band.

For multiple-cell WLANs, the limited availability of channels implies that they must be re-used, much like in cellular communication networks. But unlike in cellular networks, the number of channels available in wireless LANs is not adequate to ensure both contiguous coverage (which is essential for roaming) and interference-free connections at the same time. As a result, cells assigned the same channel may experience co-channel interference from nearby users The range of wireless LANs is limited. For 801.11b the range is 300 feet, while 802.11a products have half that range.

Use of directional antennas at the AP in a cell of a wireless LAN can enhance the system's performance because they increase range and/or capacity, as they do for the base station of a cell in a cellular system. Directional antennas reduce the impact of co-channel interference, noise and other effects that can degrade signal quality relative to that experienced with an omni-directional antenna. By focusing the radio resources of a multiple-element and possibly multiple beam antenna array in a given direction, the range can be extended. Such antennas focus the gain pattern in the desired direction of both receive and transmit antennas. By using separate radios at the AP for each beam of a given channel, simultaneous transmissions (on the same channel) can be sent from the AP to client stations illuminated by different beams. Similarly, the AP can receive transmissions from clients illuminated by different beams.

Use of directional antennas, however, may obstruct the performance of the medium access control protocol used in the WLAN. If the client stations employ omni-directional antennas, client stations covered by different beams emanating from the AP may or may not hear one another, depending on their separation distance or signal attenuation between them. Client stations that employ directional antennas pointing to the AP will not be able hear client stations covered by different AP-antenna beams. So, in general, there will be AP-antenna beams whose covered client stations can transmit simultaneously without colliding. For ease of presentation, we will assume here that the client stations are such, or so situated, that the AP can hear and successfully decode packets sent simultaneously by a pair of client stations in different beams, but packets from a pair of clients in the same beam will collide if transmitted at once. The results derived under this assumption can be generalized for the hybrid case, where there exists the possibility of inter-beam collisions between client stations.

The AP cannot transmit and receive simultaneously on the same channel on different beams of a multi-directional antenna system. This poses no concern with systems where different channels are dedicated to downlink and uplink communication (to and from the client stations from and to the AP), like cellular systems. However, systems—like Wireless LANs—that use time division duplexing (TDD) in order to provide two-way communication on a single channel are impacted adversely. In order to take advantage of multiple beams, it is important to coordinate downlink and uplink transmissions so they coincide as much as possible with other transmissions on the same direction. Channel access control must allocate channel time in the two directions with that goal in mind.

MAC Protocols for WLANs

Channel access mechanisms for asynchronous data transfer commonly fall into two categories: distributed contention based and centralized contention free. Under contention-based access methods, stations access the channel when there is data to transmit, thus risking collision with transmissions attempted by other stations. Aloha and CSMA are examples of two such MAC protocols. The distributed random access protocol in 802.11 WLANs, known as the distributed coordination function (DCF), is based on CSMA. Contention-free access methods permit a single station to transmit at a time. With centralized contention-free protocols, a controller—typically the AP—polls stations to send or receive data. The deterministic polling protocol in 802.11 wireless LANs is known as the point coordination function (PCF).

Stations associated with a cell compete for channel access for a variety of reasons. These include the transmission of data packets; the reservation of the channel for the transmission of data packets; or the reservation on the polling list of a deterministic multiple access protocol, like PCF. The PCF relies on distributed multi-access methods to claim the channel.

With Aloha, stations with frames to transmit will attempt to seize the channel upon receiving a new packet. If there is a collision, the transmission will be attempted again after a random delay. Transmission by the AP would collide with an uplink transmission on any of the beams and transmission from a client station would collide with transmissions from the AP. There is no collision experienced, however, if two client stations in different beams transmit simultaneously (based on our assumption), or if frames are sent from the AP on two different beams. To avoid the probability of collision, it is important to transmit co-directional packets together. But while the AP can coordinate its transmissions on the downlink, the client stations cannot. Therefore, it is important to be able to coordinate uplink transmissions as well, in order to reduce the probability of collision and increase goodput.

Special MAC protocols were needed for wireless LANs for the following reasons: transmission is flawed by higher bit error rates, different losses are experienced on a wireless channel depending on the path on which the signal travels, and a radio node cannot listen while transmitting. Additive noise, path loss and multipath result in more retransmissions and necessitate acknowledgements, as successful transmission cannot be taken for granted. The different losses experienced along different paths cause different nodes to receive transmissions at different strengths, giving rise to the phenomenon of ‘hidden terminals’. [See E. A. Tobagi and L. Kleinrock. Packet switching in radio channels: Part II—the hidden terminal problem in carrier sense multiple-access and the busy tone solution. IEEE Transactions on Communications, COM-23(12):1417-1433, 1975.] These are terminals that cannot hear or be heard by the source, but are capable of causing interference to the destination of a transmission. The message exchange mechanism known as Request-to-Send/Clear-to-Send (RTS/CTS) alleviates this problem. [See P. Karn. MACA—a new channel access method for packet radio. In AARUCRRL Amateur Radio 9th Computer Networking Conference, pages 13440, 1990.] RTS/CTS provides also a reservation mechanism that can save bandwidth in wireless LANS.

The inability to detect a collision as quickly as it can be detected on cable with CSMA/CD (carrier-sense multiple access with collision detection) causes more channel time to be wasted in a collision while waiting for the entire frame to transmit before the collision is detected. Hence, carrier sensing is combined with backoff when a new frame arrives to give CSMA/CA (carrier-sense multiple access with collision avoidance).

All channel reservations, generated either with an RTS/CTS exchange or for a CFP, are made with the aid of the Network Allocation Vector (NAV), a timer maintained by all stations; the NAV is set at the value of the duration field broadcast when the reservation is announced, either by the RCTS or CTS frames, or with the PCF beacon. All stations in a cell defer access until the NAV expires. The NAV thus provides a virtual carrier sense mechanism.

Receiving signals at different strengths, depending on their origin, gives rise to capture effects. A known capture effect, the “near-far capture”, results from stronger signals being received successfully, while other stations transmit at the same time. It leads to inequities, as throughput is greater for nearby stations while distant stations are starved. In infrastructure WLANs, where all communications occur through the AP, the inequity can be remedied by applying power control at the station (i.e., on the uplink). By equalizing the signal strength received at the AP, all transmissions have equal probability of success.

We present here another form of capture, which we call “uplink capture”, that arises when directional antennas are used at the AP. This capture effect occurs because imbalance can arise in the opportunity for the AP to access the channel, which could result in downlink delay and jitter and overall capacity loss. In this document we describe the uplink capture phenomenon and propose a method to prevent its occurrence.

The remainder of this section gives some background on the existing EEE 802.11 standard MAC protocols and on enhancements presently under consideration for adoption into this standard.

IEEE 802.11 MAC Protocols

Two channel access mechanisms are standardized for the IEEE 802.11 MAC sublayer, which must co-exist: the distributed coordination function (DCF) and the point coordination function (PCF). The DCF is required and is the sole access mechanism in ad hoc networks. The PCF is an optional access mechanism, designed to facilitate periodic time-bounded traffic. [See IEEE 802.11-1999.]

The DCF of 802.11 WLANs employs the CSMA/CA protocol. The rules for CSMA prohibit a station from attempting transmission of a newly arrived packet if the channel is busy. Carrier sensing is used in order to determine whether the channel is idle. If not idle, transmission is deferred by a randomly selected delay following completion of the current transmission; this avoids collision with transmission attempts by other stations waiting for the release of the channel. Hence, collision avoidance (CA) is combined with CSMA. This deferral time is used to set the backoff timer, which is decreased only when the channel remains idle following a transmission for a period equal to the Distributed Inter-Frame Space (DIFS). Transmission is attempted when this timer expires. Transmission is attempted when this timer expires. The DCF employs the RTS/CTS message exchange as a means of dealing with hidden terminals and to reserve the channel for longer transmissions.

Under the PCF, the channel is reserved for a time interval, the contention-free period (CFP), during which the AP transmits its data and polls other stations in the cell, one at a time, to receive and transmit data. The AP sends a beacon to initiate the CFP and a special frame to designate its completion. The beacon contains the repetition time of a CIFP, which is observed by stations in the BSS; the stations refrain from transmitting when a new CFP is due to start. Since DCF and PCF must co-exist on the same channel, an AP accesses the channel by contention; it seizes the channel before any stations contending through DCF by waiting after completion of a transmission for a shorter idle period than is required of DCF stations. To access the channel following a transmission, a DCF station must wait for an idle time interval equal to DCFS, which is longer than the PCF Inter-Frame Space (PIFS), the waiting time for the AP.

The IEEE 802.11e Draft Standard

A special IEEE 802.11 study group is presently considering enhancements to the MAC protocols that achieve acceptable quality of service (QoS). Proposals for both a QoS enhanced DCF (EDCF) and a QoS enhanced PCF (EPCF) are under review.

The proposed EDCF employs CSMA with the following differences: transmission deferral and backoff countdown depend on the priority classification of the data. A station still waits for an idle time interval before attempting transmission following a busy period, but the length of this interval is no longer equal to DIFS; instead it is equal to the Arbitration-Time Inter-Frame Space (AIFS), which varies with the priority of the data. A shorter AIFS is associated with higher priority data. As a consequence, higher priority data gets to the channel faster. In addition, countdown of the backoff timer does not commence when a busy period completes unless the channel has been idle for a period equal to AIFS. This causes backoff countdown of lower priority frames to slow down, and even freeze if there are higher priority frames ready to transmit, a common occurrence in congestion. Following a successful EDCF contention, a sequence of frames separated by idles gaps not longer than the interval designated ‘SIFS’ in 802.11 standard can be transmitted without contention. Such a sequence, known as a TXOP, is protected by the NAV. The proposed EPCF maintains multiple traffic queues at the stations for different traffic categories; higher priority frames are scheduled for transmission first. Delays are reduced through improved polling-list management. Only active stations are kept on the polling list; a station with data to transmit must reserve a spot on that list, where it stays as long as it is active and for a limited number of inactive polling cycles. A reservation is needed to place a station on the polling list.

EPCF provides a generalization of PCF. It allows for contention-free transfers and polling to occur as needed; not necessarily at pre-determined regular repeat times, as provided by the PCF. The AP can thus send (and possibly receive) data to stations in its BSS on a contention-free basis. This contention-free session, referred to as a controlled access period (CAP), helps an AP transmit its traffic, which is typically heavier in infrastructure cells (since stations must communicate exclusively through the AP). As in the case of the PCF, the EPCF permits access to the channel by the AP after waiting for an idle period of length equal to PIFS.

### SUMMARY OF THE INVNTION

A method and system are disclosed to remedy ‘uplink capture’, a new capture effect that arises when multiple-beam directional antennas are employed in multiple-cell wireless local area networks (WLANs) that use distributed random access mechanisms. Without special measures, an imbalance could arise in the opportunity for the AP to access the channel, which could result in downlink delay and jitter and overall capacity loss. We present here methods for distributed channel access and dynamic bandwidth allocation that improve performance.

### DESCRIPTION OF THE FIGURES

FIG. 1 illustrates a wireless system using directional antennas, where two beam illuminate two client stations, D and F, which can transmit uplink at the same time.

FIG. 2 illustrates the effect of the delay caused by “uplink capture” for two client stations, D and F, which take turns transmitting instead of transmitting in parallel.

FIG. 3 illustrate uplink transmission acknowledgement and use of the NAV for simultaneous channel release along multiple beams

FIG. 4 illustrates downlink and uplink transmissions along a single beam, with dummy frames on the downlink and multiple TXOPs per super-frame.

### DESCRIPTION OF THE PREFERRED EMBODIMENT

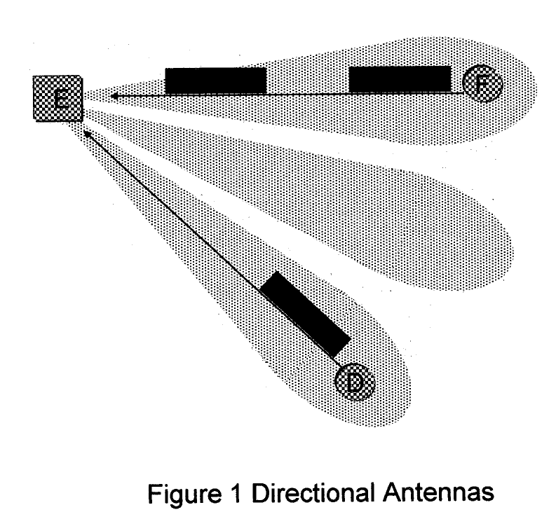

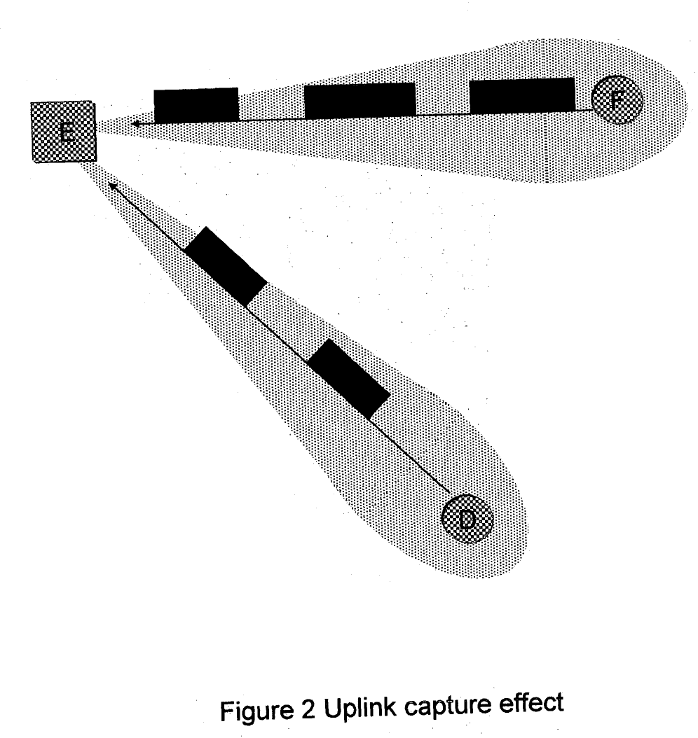

Directional antennas increase the traffic load that can be carried on a given channel, as stations illuminated by different beams can transmit simultaneously on the same channel. FIG. 1 illustrates a wireless system using directional antennas, where two beam illuminate two client stations, D and F, which can transmit uplink at the same time. When using carrier sensing in combination with multiple-beam directional antennas, the AP is at a disadvantage relative to the client stations. While clients covered by different antenna beams cannot hear one another (according to our assumption), and thus may transmit on the same channel simultaneously, the AP is prevented from transmitting if any of the client stations transmit. This leads to a capture effect favoring uplink transmissions at the expense of downlink transmissions. The problem is illustrated in FIG. 2, which depicts an access point node E, and two nodes, D and F, communicating with E via wireless connections. D and F can be two client stations of a wireless LAN. Alternatively, nodes D and F can be hubs, concentrating traffic that is backhauled to the access point E. Simultaneous co-channel (on the same channel) transmissions can be sent to the AP from these two stations, which are illuminated by different beams. The AP in this system cannot simultaneously communicate, on the same channel, with both of the stations in opposite directions in the case of multiple-beam directional antennas. The term “directional antenna” will be used herein to refer to the type of antenna system that enables communication between the AP and two different stations simultaneously in the same direction (uplink or downlink), but not in different direction using the same channel, provided the stations are covered by different beams.

While the AP can send all of its downlink transmissions [from the AP to the client stations] simultaneously, the uplink transmissions cannot be coordinated. Arriving independently of one another, they will be transmitted upon arrival, provided the client sees the channel as idle. Because of multiple beams, it is possible for one station to start transmitting before another one—covered by a different beam—finishes, according to our assumption. This way, uplink transmissions can capture the channel.

Uplink capture causes both losses in channel utilization efficiency and greater delay and/or jitter on the downlink. While there is potential for multiple parallel transmissions, it is not taken full advantage of. The channel is occupied with time-staggered uplink transmissions causing downlink transmissions to be delayed while waiting for the channel to become free. New arrivals of frames at the client stations prolong the delay experienced by the frames queued at the AP. So while downlink transmissions can be transmitted in parallel, utilizing the channel efficiently and causing minimal delay to the uplink transmissions, they will experience delays caused by uplink transmissions that are strung out in time. Hence the result is both sub-optimal utilization of the channel and increased delay and jitter on the downlink. This capture effect is expected to have adverse implications for QoS.

Remedy for Uplink Capture

I. Dealing with the Asymmetry Caused by Directional Antennas

The way to mitigate problems caused by the asymmetry in channel access arising with directional antennas is to induce multiple uplink transmissions to occur simultaneously. Allocation of the channel time, or bandwidth, between segments dedicated to uplink and to downlink transmission, respectively, would achieve this goal. This allocation would require synchronization of all stations. Pre-assigning the time for downlink and uplink transmission transmissions, respectively, increases channel utilization efficiency.

With Aloha, packets transmitted by the AP would not experience collisions if a separate queue is maintained for each destination beam. The uplink transmissions would collide only with simultaneous transmissions from client stations covered by the same beam. With CSMA, aggregating uplink transmissions in time avoids capture of the channel by uplink transmissions.

Allocation of channel time to each direction could be either fixed/static (time-variable allocations that are constant for a period of time) or dynamic (allocations changing on a packet-by-packet basis). With fixed allocations, the duration of the time interval in which transmission is allowed in each direction is determined in advance. The simplest form of bandwidth allocation is to assign equal length time intervals, alternating along each direction. This is a variation of Slotted Aloha (or Slotted CSMA), which we call Directional Slotted Aloha (or Directional Slotted CSMA). Typically, traffic load along the two directions is not the same, leading either to the channel sitting idle because of insufficient traffic to fill the allotted channel time, or to increased delay/jitter if there more backlogged traffic than the time allotted for its transmission. The length of the transmit time intervals along each direction could be made proportional to the traffic load expected along each direction, and one could employ static allocations that adapt to traffic in order to reduce the channel idle time or delay and jitter. This notwithstanding, the channel could still end up sitting idle because of the stochastic nature of traffic. At any moment, the allotted time could be more or less than needed. The result would be less efficient utilization of the channel and increased delay/jitter. Improvement over adaptive bandwidth allocation is achieved with a dynamic bandwidth allocation method that allocates bandwidth as needed. We describe such a method below for a CSMA channel access protocol.

A. Directional Dynamic Bandwidth Allocation (DDBA)

Dynamic bandwidth allocation allows for adjustments to be made along each transmission direction (downlink and uplink) so that the channel is utilized fully. It can be achieved either by centralized or distributed approaches. In a centralized approach, a central controller, like the AP, determines the times transmission is allowed in either direction, based on the observed traffic loads or other congestion or QoS-related metrics, and announces them to the client stations. A variety of algorithms could be used to this end, which are based on either optimization techniques or heuristics. For instance, a total time period could be assigned for the sum of the uplink and downlink times, based on the QoS requirement of real-time applications. The period could be divided in proportion to a running average of recent traffic load in each direction. A similar method would use a time-weighted running average of recent traffic load in each direction. One or both directions could be assigned enough time to transmit an estimate of the backlog in that direction, up to a maximum time unit.

Alternatively, one could employ a distributed approach. It requires all stations to be synchronized, and all client stations are required to release the channel at pre-specified times—we refer to this requirement as Uplink Channel Release (UCR). Then, the synergy among the uplink transmissions in capturing the channel is eliminated. If there is downlink traffic queued, the AP would have the opportunity to contend for the channel at the time the channel is released. With QoS-enhanced EDCF, because of its top priority treatment, the AP will prevail over client stations competing to access the channel and will transmit successfully. (Priority is afforded to the AP by allowing it to access the channel after an idle time shorter than for any client station—i.e. at PIFS.)

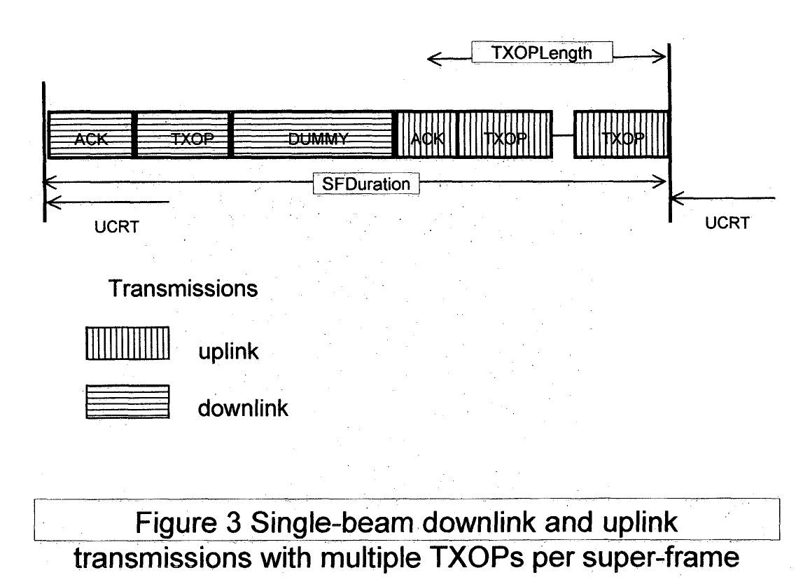

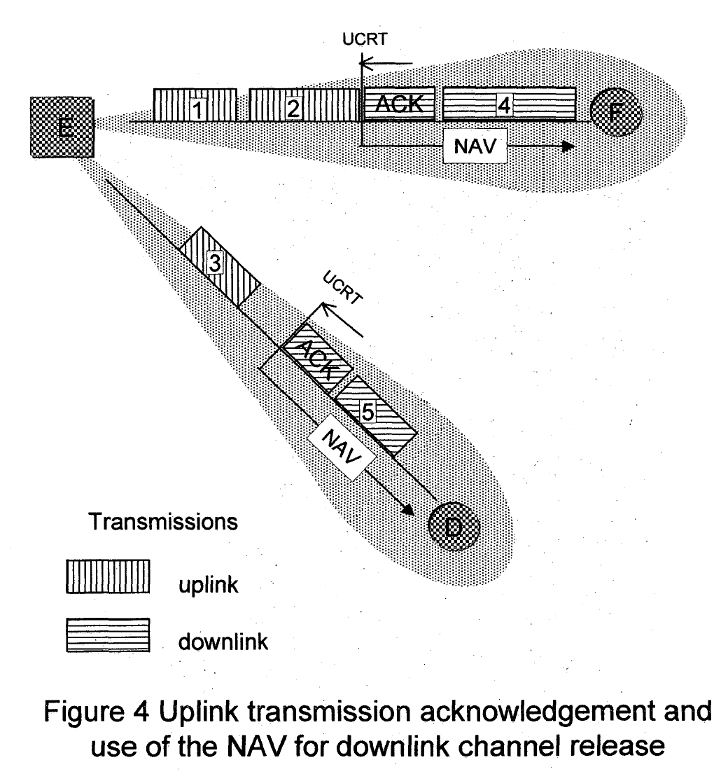

Downlink transmissions occur simultaneously on all beams. If there is more traffic to be transmitted on one beam than on the others, the AP must even out the time that the channel is occupied by downlink transmissions on all beams in order to prevent clients from accessing the channel while the AP is transmitting on another beam. If the clients rely on carrier sensing to establish that the channel is idle, the AP evens the traffic sent on all beams by supplying dummy frames. FIG. 3 shows dummy frames used by the AP in order the keep the channel busy until it becomes available for use by uplink transmissions. If the clients rely on virtual carrier sensing (e.g. the NAV) to establish that the channel is idle, the AP adjusts the durations indicated in frames transmitted on all beams so that channel reservations expire simultaneously on all beams. Once all downlink traffic has been transmitted (or the stations' NAV has expired), the client stations seize the channel and transmit their queued frames, in parallel if in different antenna beams. FIG. 4 illustrates uplink transmission acknowledgement on two beams. Each beam is reserved along the downlink direction

As in the case of scheduled bandwidth allocation, the postponement of uplink transmission increases channel utilization efficiency as more uplink transmissions occur in parallel. Uplink capture is eliminated and the delays/jitter experienced in the downlink is minimal. We refer to this algorithm as Directional Dynamic Bandwidth Allocation (DDBA).

The timing requirements imposed by UCR would necessitate change in the acknowledgement policy. The 802.11 MAC policy requires that an acknowledgement be sent within a specified time interval of length SIFS following successful receipt of a frame. According to the 802.11 standard, a station has the option to forego acknowledgements. Another acknowledgement policy being proposed for the 802.11e standard, enables the sending station to relax the requirement for acknowledgement after each frame, but upon request, receive an acknowledgement for receipt of multiple frames. With DDBA, there can be no requirement of immediate acknowledgement to transmission, as the receiving end cannot always access the channel within a SIFS time interval. The acknowledgement policy would have to be modified.

If acknowledgements are desired, they would have to be delayed until the next time the destination node (station or AP) is allowed to contend for the channel. If acknowledgment is not received by the time the sending node(s) may transmit again, the frame will be retransmitted. The AP can send acknowledgements after a PIFS idle time interval without contention. The channel time used for acknowledgement can be reduced if the AP or a station is allowed to combine in a single frame acknowledgements for multiple frames to the same origin (station or the AP). The AP could also combine in a single frame the acknowledgement for the frames received from all stations within a beam. Such an acknowledgement could be sent within a specified time interval (say PIFS) from the time the channel is released for do, without contention.

In general, acknowledgements to downlink transmission would be sent by a collision avoidance medium access control protocol in order to avoid collision between transmissions of acknowledgements from stations within the same beam. If the AP stopped transmission (and wait for acknowledgement) before transmitting frames to a second station in the same beam, there would be only one acknowledgement due in each beam when the AP released the channel. That acknowledgement could be sent without contention.

It should be noted that Global Channel Release—i.e., requiring both the AP and the client stations, to release the channel at pre-determined times—would work, too, in the same way. Since the AP has priority over the client stations, it will recapture the channel immediately following channel release, and will transmit any remaining queued frames. A Global Channel Release would result in less efficient channel utilization compared to Uplink Channel Release.

DDBA is simple to use, as it requires no special intelligence for adaptation to traffic or centralized control. While fixed/static bandwidth allocation is simple, too, it lacks the channel utilization efficiency of dynamic bandwidth allocation. By retaining distributed control, DDBA provides a natural extension for the (E)DCF in IEEE 802.11, to help maximize the benefit achievable from directional antennas.

Pseudo-Slotted CSMA

Uplink channel release could occur at regularly spaced time intervals that are sufficiently close to meet delay and jitter restrictions for periodic time-critical applications such as real-time voice or video. This implies synchronizing all stations in a BSS, and segmenting the channel into super-frames. The resulting protocol would be a pseudo-Slotted CSMA.

An important difference between slotted CSMA and pseudo-slotted CSMA is that the frame size in the former is fixed, which is not the case in the latter. We also generalize the concept of a transmission to cover not only a single frame, but also TXOPs—i.e. frame sequences generated without contention, following a contention success. The frames in the TXOPs are separated by SIFS idle spaces and are all transmitted in the same direction. Such a sequence could be sent either without a requirement for acknowledgement, or with acknowledgement for the arrival of the entire frame sequence sent at the time the channel is released.

Uplink Channel Release requires that the channel be free of all uplink transmission at pre-specified times, UCRT. In the example of uplink and downlink transmissions illustrated in FIG. 3 for a single beam, the channel time is slotted at equal time intervals, which give rise to super-frames of duration SFDuration. In general, it is not necessary for the channel to be released after each TXOP; release may be required less often. There can be multiple TXOPs per super-frame. The length SFDuration of a super-frame should be set according to the QoS requirements of time-critical applications.

In general, there will be both downlink and uplink traffic in a super frame. How much of each will vary dynamically in response to the traffic load experienced in each direction. Downlink traffic, if there is any queued, will be transmitted when the channel is released by all stations, which will occur immediately following uplink channel release, or sooner if there is no traffic queued at any of the stations. Uplink traffic will be transmitted when the AP releases the channel. The dynamic allocation of channel time between the uplink and downlink transmission directions achieved with DDBA causes the channel to be utilized more efficiently than with fixed allocation of bandwidth to each transmission direction.

Clock Synchronization

In order to adhere with an uplink channel release schedule, all stations in the cell must be synchronized. Synchronization is achieved in the 802.11 WLANs through the use of the IEEE 802.11 timing synchronization function (TSF) keeps the timers of all stations within a cell synchronized. The AP initializes its TSF timer and periodically transmits time-stamped frames, in order to synchronize the other stations in the BSS. The time-stamped frames may be transmitted on the same wireless channel like other data, or wireless signaling channels set up for this purpose. The stations update their timers after making the proper adjustments for propagation and processing delays.

Synchronization of the clocks of all stations within the same cell can be achieved the use of a network time reference, such as an NTP server. Synchronization can be achieved also by extracting time information from signals generally available outside the network. For instance, radio signals intended for navigation and positioning can be used to synchronize the stations and AP in a cell. Similarly, radio signals intended for national time synchronization can be used for that purpose.

Illustrative examples of the invention have been described in detail. In addition, however, many modifications and changes can be made to these examples without departing from the nature and spirit of the invention.

What is claimed is:

1. A method for distributed medium access that schedules transmission of frames on a channel in a wireless access network comprising an access point and a plurality of stations illuminated by multiple beams of an antenna system emanating from said access point, which antenna system does not enable simultaneous communication on the same channel in opposite directions between said access point and any two stations covered by different beams, in a way that reduces channel capture, comprising the steps of:
Said stations transmit according to a medium access protocol that allows the initiation of transmission only when the channel is idle; and
requiring all stations engaged in uplink transmission to release the channel at the same time, causing the channel to become idle at that time and thus preventing capture of the channel by uplink transmissions.

2. The method for distributed medium access of claim 1, which further comprises:
Requiring the access point to terminate downlink transmission on all beams simultaneously, causing the channel to become idle at that time and thus preventing uplink transmissions that will not be received successfully at the access point.

3. The method for distributed medium access of claim 1 or claim 2, which further comprises:
Determining whether the channel is idle through carrier sensing.

4. The method for distributed medium access of claim 1 or claim 2, which further comprises:
Determining whether the channel is idle through timers maintained at the non-transmitting stations and set to the duration value indicated upon reservation of the channel.

5. The method for distributed medium access of claim 1, which further comprises:
Synchronizing the clocks of the stations; and
requiring the times at which stations engaged in uplink transmissions to release the channel to conform to a previously-designated schedule.

6. The method for distributed medium access of claim 3, which further comprises:
The access point transmitting dummy frames on certain beams so as to cause transmission on all beams to terminate simultaneously.

7. The method for distributed medium access of claim 4, which further comprises:
The access point setting the duration of channel reservations on different beams so as to cause channel reservations on all beams to terminate simultaneously.

8. The method for distributed access of claim 5, which further comprises:
Having several release schedules specified and distributed previously, and one chosen based on time of day.

9. The method for distributed access of claim 5, which further comprises:
Having several release schedules specified and distributed previously, and one chosen based on network conditions.

10. The method for distributed medium access of claim 5, which further comprises:
Achieving synchronization of the clocks of all nodes within the same cell by the AP transmitting over the air a frame containing a timestamp to which all associated nodes set their clocks.

11. The method for distributed medium access of claim 5, which further comprises:
Achieving synchronization of the clocks of all stations within the same cell by requiring some or all stations to extract time information from signals generally available outside the network

12. The method for distributed medium access of claim 11, which further comprises:
Achieving synchronization of the clocks of all stations within the same cell by extracting time readings from radio signals intended for navigation and positioning

13. The method for distributed medium access of claim 11, which further comprises:
Achieving synchronization of the clocks of all stations within the same cell by extracting time readings from radio signals intended for national time synchronization

14. The method for distributed medium access of claim 5, which further comprises:
Achieving synchronization of the clocks of all stations within the same cell by the use of a network time reference, such as an NTP server.

15. The method for distributed medium access of claim 1, which further comprises:
Timing acknowledgement of successful receipt by the access point of frames transmitted uplink to occur before the access point relinquishes the channel for uplink transmission, thus enabling a station whose transmission remains unacknowledged by the time the station may access the channel again to retransmit said frame at that time.

16. The method for distributed medium access of claim 2, which further comprises:
Timing acknowledgement of successful receipt by a station of frames transmitted by the access point to occur, before the station relinquishes control of the channel thus enabling the access point to retransmit any frames that remain unacknowledged by the time the AP regains control of the channel.

17. The method for distributed medium access of claim 2, which further comprises:
Limiting transmissions that occur while the access point has control of the channel to frames that do not require acknowledgement and to frames directed to a single station per beam, thus permitting acknowledgement by such station to be sent without contention.

18. The method for distributed medium access of claim 15, which further comprises:
Using a compound acknowledgement for all frames transmitted uplink by a single station and during the time interval between two consecutive designated channel release times, thus reducing the channel time used for acknowledgements.

19. The method for distributed medium access of claim 16, which further comprises:
Using a compound acknowledgement for all frames transmitted by the access point to the same station and during the time interval between two consecutive designated channel release times, thus reducing the channel time used for acknowledgements.

20. The method for distributed medium access of claim 15, which further comprises:
Using a compound acknowledgement for all frames transmitted uplink by stations covered by the same beam and during the time interval between two consecutive designated channel release times, thus reducing the channel time used for acknowledgements.
